(19) United States
(12) Patent Application Publication
(10) Pub. No.: US 2003/0073435 A1
(43) Pub. Date: Apr. 17, 2003

(54) System and method for controlling interference affecting satellite terminals in a satellite communications network by establishing and using virtual cells which are independent of the cells formed by the spot beams generated by the satellite

(76) Inventors: Steven Thompson, Germantown, MD (US); David Whitefield, Darnestown, MD (US); Arthur Kaupe, Chevy Chase, MD (US); Andrew Barnhart, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/975,051

(22) Filed: Oct. 11, 2001

(51) Int. Cl. H04Q 7/20

(52) U.S. Cl. 455/428; 455/1

(57) ABSTRACT

A system and method for controlling interference affecting user terminals in a communications network, such as satellite terminals in a satellite communications network, by establishing and using virtual cells which are independent of the cells formed by the spot beams generated by the satellite. The system and method employs an interference detector which is adapted to detect interference in the network which interferes with an ability of at least one user terminal to communicate in the network, and an interference source identifier which is adapted to identify a source of the interference by deactivating at least one select group of the user terminals based on criteria independent of the respective cell or cells in which the user terminals reside, to locate those terminals whose ability to communicate in the network is being interfered with by the detected interference. The interference source identifier can deactivate the select group or groups of terminals based on criteria such as user terminals which are all located within a portion of a single cell, user terminals which are located within multiple cells, user terminals which are all located in a respective geographic region having a size independent of a size of any of said cells, user terminals having data receiving addresses within a particular range of addresses, user terminals having user terminal identifiers within a particular range of user terminal identifiers, and user terminals having a particular supplier identifier which identifies a supplier of the user terminals, to name a few.

### CROSS-REFERENCE TO RELATED APPLICATION

Related subject matter is disclosed in a copending U.S. Patent Application of Steven Thompson et al. entitled “A System and Method for Managing Congestion Caused by Satellite Terminals in a Satellite Communications”, Attorney Docket No. PD-200306, filed even date herewith, the entire contents of which is incorporated herein by reference.

### BACKGROUND OF TEE INVENTION

1. Field of the Invention

The present invention relates to a system and method for controlling interference affecting satellite terminals in a satellite communications network by establishing and using virtual cells which are independent of the cells formed by the spot beams generated by the satellite. More particularly, the present invention relates to a system and method that is capable of isolating and deactivating improperly operating satellite terminals in a satellite communications network based on desired parameters and independent of their presence in a particular spot beam or cell.

2. Description of the Related Art

Satellite communications networks exists which are capable of enabling transmission of various types of data, such as voice and multimedia data, to stationary and mobile user terminals. A satellite communications network includes one or more satellites, such as geosynchronous earth orbit (GEO) satellites, medium earth orbit (MEO) satellites, or low earth orbit (LEO) satellites which are controlled by one or more network operations control centers (NOCC). The satellites each project radio frequency communications signals in the form of spot beams onto the surface of the earth to provide the stationary or mobile user terminals access to the network.

That is, each spot beam irradiated by a satellite will cover a particular region of the earth's surface. Because GEO satellites orbit the earth at a speed substantially equal to that of the earth's rotation, spot beams generated by GEO satellite will each cover a designated area of the earth's surface. However, because MEO and LEO satellites orbit the earth at speeds which are typically much greater than the speed of rotation of the earth, the spot beams generated by these types of satellites will traverse the earth's surface.

A mobile user terminal is typically configured in the form of a hand-held unit, such as a mobile telephone having an antenna for transmitting and receiving signals, such as voice data signals, to and from the network. A stationary terminals, on the other hand, typically has a satellite dish which acts as the antenna for transmitting and receiving signals, such as voice, data or multimedia signals, to and from the network. These types of stationary terminals are typically referred to as satellite terminals or STs.

As can be appreciated by one skilled in the art, the STs within a region covered by a particular spot beam will transmit and receive data to and from the satellite communications network via the satellite in, for example, a time-division multiple access (TDMA) or code-division multiple access (CDMA) manner, over carrier waves having frequencies within the range of frequencies allocated to the spot beam. Each region is commonly referred to as a cell. Typically, networks of this type further divide their spot beams into smaller regions or cells by dividing the range of frequencies allocated to the spot beam into smaller ranges and allocating each of those smaller ranges to respective portions of the region covered by the spot beam. For example, a network may be configured so that each spot beam provides one uplink cell for receiving data from all of the STs in the cell, and a number of associated downlink cells, for example, seven downlink cells, with each downlink cell being used to transmit data from the network to a respective group of STs in a particular section of the spot beam.

The amount of bandwidth that the network can allocate to any particular ST within a cell is thus limited by the amount of bandwith allocated to other STs within that cell. Typically, networks of this type are configured to allocate what is believed to be a sufficient amount of bandwidth to each uplink and downlink cell based on the number of STs that are believed to be in use in each cell. However, certain problems can arise if the resource use in a cell increases to a level that causes STs within the cell to be denied service.

For example, an ST within a cell that is operating in an improper or unauthorized manner can begin to “sweep the band” or, in other words, start transmitting on all available channels allocated to the cell. When this occurs, other STs within the cell are prevented from accessing those channels. This type of unauthorized or improper ST can be referred to as a “rogue ST”.

A satellite communications network can detect that a cell has a rogue ST by monitoring the data transmission error rate of the cells. That is, if a particular cell exhibits an unusually high error rate, the network will suspect that that cell includes one or more terminals. The network can then proceed to identify and deactivate the rogue terminal by systematically deactivating the STs in the cell in question and checking for an improvement in the error rate. Because each of the STs has an identifier, such as a unique serial number, that is known by the network, the network can deactivate the STs in any particular cell on an ST by ST basis. Accordingly, when the network deactivates an ST in the cell in question and determines that the error rate of the cell in question has dramatically improved, the network can conclude that the deactivated ST is the rogue ST, and leave that ST in a deactive state until the problems with the ST can be resolved.

Although the method described above for identifying a rogue ST and thus eliminating interference in cells in the network can be effective, this method can be time consuming because the STs are deactivated one at a time. While the network is in the process of identifying the rogue ST, the rogue ST can continue to interfere with data transmission from valid STs. Moreover, it is often necessary with this method to deactivate and reactivate a large number of STs before ultimately identifying the rogue ST.

Accordingly, a need exists for an improved system and method for managing and eliminating interference in satellite communications networks caused by rogue STs.

### SUMMARY OF THE INVENTION

An object of the present invention is to provide a system and method that is capable of isolating and deactivating improperly operating satellite terminals in a satellite communications network based on desired parameters and independent of their presence in a particular spot beam or cell.

These and other objects are substantially achieved by providing a system and method for managing interference in a communications network, such as a satellite communication network, which establishes communication cells at respective locations on the surface of the earth to enable communication between a plurality of user terminals, such as satellite terminals. The system and method employs an interference source identifier which is adapted to identify a source of interference in the network, which interferes with an ability of at least one user terminal to communicate in the network, by deactivating at least one select group of the user terminals based on criteria independent of the respective cell or cells in which the user terminals reside, to locate those terminals whose ability to communicate in the network is being interfered with by the detected interference. The interference source identifier can deactivate the select group or groups of terminals based on criteria such as user terminals which are all located within a portion of a single cell, user terminals which are located within multiple cells, user terminals which are all located in a respective geographic region having a size independent of a size of any of said cells, user terminals having data receiving addresses within a particular range of addresses, user terminals having user terminal identifiers within a particular range of user terminal identifiers, and user terminals having a particular supplier identifier which identifies a supplier of the user terminals, to name a few.

### BRIEF DESCRIPTION OF THE DRAWINGS

These and other objects and advantages of the invention will become more apparent and more readily appreciated from the following detailed description of the presently preferred exemplary embodiments of the invention taken in conjunction with the accompanying drawings, of which:

FIG. 1 is a block diagram illustrating an example of a satellite communications network employing a system and method for controlling interference according to an embodiment of the present invention;

FIG. 2 is a detailed view of an arrangement of satellite terminals in cells formed by spotbeams projected by the satellite in the network shown in FIG. 1;

FIG. 3 is a flowchart showing the basic sequence of operations performed by the system and method for controlling interference according to an embodiment of the present invention; and

FIG. 4 shows an example of interference detection points detected by the system and method for controlling interference according to an embodiment of the present invention.

### DETAILED DESCRIPTION OF THE PREFERRED EMBODIMENTS

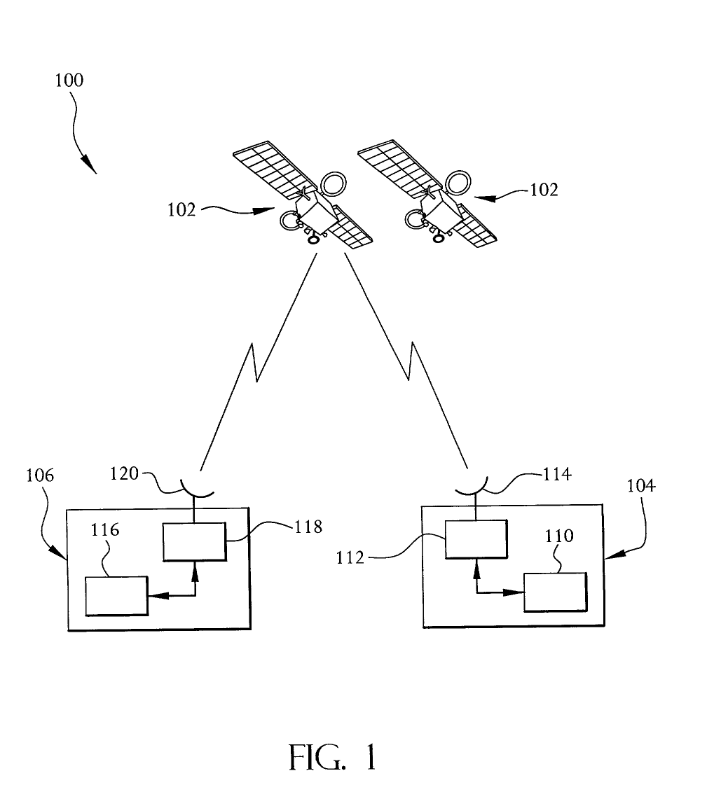

A satellite communications network 100 employing a system and method for interference management according to an embodiment of the present invention is shown in FIG. 1. The network 100 includes one or more satellites 102, such as geosynchronous earth orbit (GEO) satellites, medium earth orbit (MEO) satellites, or low earth orbit (LEO) satellites which are controlled by one or more network operations control centers (NOCC) 104. In this example, the satellite 102 is a GEO satellite.

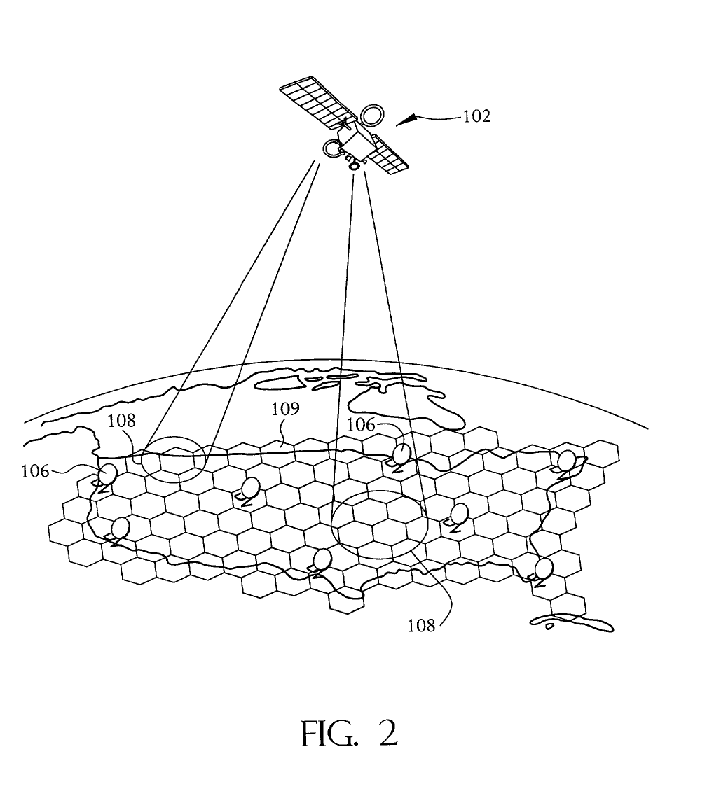

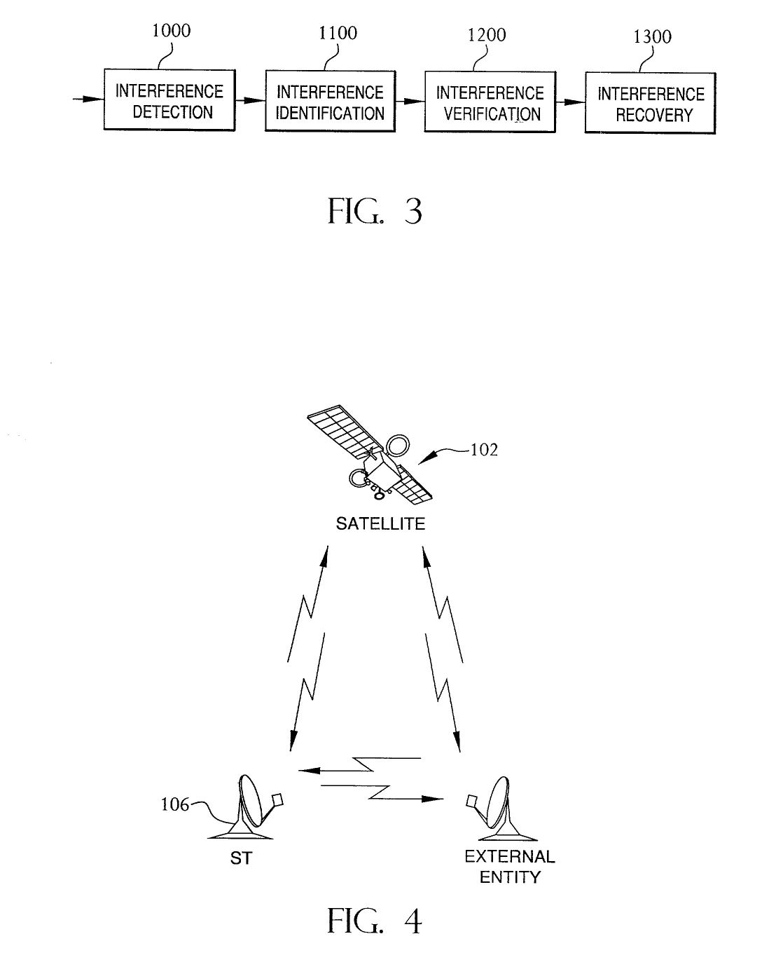

As discussed in the background section above, the satellite 102 projects radio frequency communications signals in the form of spot beams onto the surface of the earth to provide the stationary or mobile user terminals 106 access to the network. In this example, the user terminals 106 are stationary terminals or STs as described in the background section above. Because GEO satellites orbit the earth at a speed substantially equal to that of the earth's rotation, spot beams 108 generated by 104 satellite 102 will each cover a designated area of the earth's surface, as shown in FIG. 2. Each spot beam 108 includes one or more uplink and downlink cells 109 as can be appreciated by one skilled in the art. The satellite 102 is further capable of generating a CONUS beam which covers all of the regions covered by the individual spot beams 108.

As further shown in FIG. 1, the NOCC 104 includes a controller 110 for controlling operation of the satellite 102 and data communications to and from the STs 106 via the satellite 102 as discussed in more detail below. The NOCC 104 further includes a transceiver 112 coupled to an antenna 114, such as a satellite dish, for transmitting and receiving data signals, such as broadband, multimedia data signal, to and from the STs 106 via satellite 102. Each ST includes a controller 116 for controlling operation of the ST 106 and data communications to and from the NOCC 104 and other STs 106 via the satellite 102 as discussed in more detail below. The controller 116 includes a memory (not shown) for storing an identifier for the ST 106, such as a unique serial number, that is recognizable by the NOCC 104. Each ST 106 further includes a transceiver 118 coupled to an antenna 120, such as a satellite dish, for transmitting and receiving data signals, such as broadband, multimedia data signal, to and from the NOCC 104 and other STs 106 via satellite 102.

As shown in FIG. 3, a plurality of STs 106 can be present in each spot beam 108. As discussed in more detail below, the controller 110 of the NOCC 104 according to an embodiment of the present invention is capable of identifying and eliminating interference in the network 100 that is caused by, for example, a rogue ST as discussed in the background section above. However, unlike the conventional networks, the controller 110 is capable of deactivating STs 106 independently of the spot beams 108, cells or regions of the earth in which they reside. The controller 110 is capable of deactivating groups of the STs 106 based on parameters such as all or a portion of the uplink cell in which the group of STs 106 reside, all or a portion of the downlink cell in which the group of STs 106 reside, all STs 106 receiving a CONUS beam, a region of the earth dedicated to a particular satellite 102 in the network 100, a geographic region of the earth, a range of ST management destination subaddresses within a cell or microcell, a range of electronic serials numbers for the STs 106, by the serial numbers of suppliers of the STs 106, and any other suitable parameter, as discussed in more detail below.

Ideally, the system and method according to an embodiment of the present invention should enable the controller 110 in the NOCC 104 to detect all types of interference in the network. However, not all data is available, counted, or monitored all the time in order to detect all types of interference. Also, contention channel collisions and STs 106 not making use of their allocated timeslots can potentially obscure detection of some types of interference. It is therefore desirable to detect as much interference as reasonable or necessary. This must obviously be constrained by its impact and cost on the system.

In particular, as discussed in more detail below, the network 100 is able to remotely and temporarily disable sets of STs 106 to assist in interference isolation, and is able to set up an engineering channel to assist in interference management. The network 100 also able to block out particular channels and subbands in a particular uplink to avoid detected interference, to record uplink and downlink transmission statistics, and to report aggregated summary status information about excessive transmission and reception errors and statistics.

Unlike previous very small aperture terminal (VSAT) satellite communications network, the network 100 is so dynamic in terms of dynamic frequency/timeslot allocations and use of spot beams, conventional techniques like spectrum analyzers are more difficult to apply to interference management. Also, the difference between interference and some types of fraud cannot be determined generally until the intention of the interference is investigated. The intention or motivation of the people behind the interfering source is unknown until after the actual source of the interference or fraud is identified. Before the source of the interference or fraud is identified, it first needs to be detected.

An embodiment of the present invention therefore enables the NOCC 104 and, in particular, the controller 110 of the NOCC 104 to perform the following processes shown in FIG. 3 to detect and analyze interference in the network:

1. Interference Detection—Detecting that some form of interference is occurring in step 1000 by specifying the following:

a. Interference Detection Points—Determine places in the system to record information about interference;

b. Interference Detection Information—Set up mechanisms at the detection points to collect information for interference detection and report it in step; and

c. Interference Detection Analysis—Using the information collected, determine if there is possible interference;

2. Interference Identification—Determining the type, location, and source of the interference in step 1100;

3. Interference Verification—Verifying that unexpected interference is definitely occurring in step 1200; and

4. Interference Recovery—Determining how to best correct for the interference, either by disabling faulty equipment, adjusting resource plans to avoid interference, correcting misconfigured STs, turning off rogue stations remotely, even if they are not registered, or adjusting network parameters in step 1300.

It is also desirable, if possible, to differentiate between internal and external interference based upon where the interference is detected. Internal interference can be caused by network components within the network 100, while external interference can be caused by components outside of the network 100 such as STs of other networks. The difference between external and internal interference is not important until the source of the interference is being isolated. The pattern of interference can help determine if the interference is external or internal but this does not happen until after it is detected that some type of interference is occurring. If all of the registered STs are successfully shut off and there is still interference, then it is not coming from one of the registered STs and hence, is not internal interference.

In general, interference can be classified into three groups, namely, satellite-detected interference, ST-detected interference, and external-entity detected interference. Satellite-detected interference includes interference detected by the satellite 102 from STs 106, external entities, or that caused by its own components. ST-detected interference includes interference detected by the ST 106 from the satellite 102, other STs, external entities, or from interference caused by its own components. External-entity-detected interference includes not only other VSATs in other systems that may cause or detect interference, but also other satellite systems and any terrestrial (microwave) systems. These other entities may interfere either with components of the network 100, such as the satellite 102 and the STs 106, and they may also detect interference on their systems caused by components of the network 100.

The NOCC 104 provides for inband interference information collection and for tools for offline interference analysis at the NOCC 104 in order for NOCC operators to perform interference detection. The NOCC 104 and, in particular, the controller 110 of the NOCC 106, configures which demodulators in the payload of the satellite 102 are actively used and assigns carriers to those demodulators and supplies this information for interference detection. The demodulators are either made available for the bandwidth controller (BC) to allocate, or as end-user dedicated data contention channels. The BC is located in the payload of the satellite 102, and the demodulators are allocated to an uplink by the NOCC 106 and used by the BC.

The payload of the satellite 102 also provides time of day values in its telemetry which it provides to the NOCC 104 on observed uplink noise. The payload can further provide telemetry to the NOCC 104 on uplink traffic and uplink block decoder counts. In addition, the payload provides setting up and transmitting over an uplink engineering channel, and the payload bandwidth controller shall attempt to allocate timeslots for STs 106 requesting specific uplink channels for an ST interference test message. The satellite control facility (SCF) shall provide the capability to detect, identify, report on, verify, isolate, and recover from interference with the pilot tone and telemetry, tracking and control (TT&C) link.

The demodulator configuration information is passed to the payload of the satellite 102 from the NOCC 104, and the following pieces of information supplied by the NOCC are used for interference detection: demodulator assignments for each uplink cell and carriers lists, dedicated end-user data contention channel assignment list and channel groups. This information is used to determine the configured state of the demodulators over time and to determine which channels to expect contention channel collisions. A collision detected on a non-contention channel may indicate the presence of interference.

Estimates on the expected average utilization of contention and noncontention timeslots from the NOCC 104 as part of its output from capacity planning can also be correlated with the expected resource utilization. These estimates provide some indications of possible interference while attempting to compensate for allocated but unused contention and non-contention timeslots.

In addition, all assigned satellite payload demodulators transmit their aggregated noise measurement telemetry directly to the NOCC 104 every frame. The noise measurement telemetry is sent from the payload to the NOCC 104, and the following pieces of information are used for interference detection: uplink frame number timestamp (TOD), noise measurement record for each demodulator, demodulator ID, identifier for a demodulator and an aggregated noise measurement over the demodulator across all 24 2 Mbyte channels for the given frame.

If the aggregated noise measurement shows unexpected trends, drastic changes, or excessively high values, then there may be possible interference. Specifically, the noise measurements are one of the primary “trip-wires” for frequency/subband interference detection. The data is provided to NOCC network engineers for offline data mining. Also, the NOCC 104 does not automatically perform data mining, but rather provides the data and the tools to assist NOCC network engineers to do this. When interference is indicated in a particular uplink cell, then further information is collected from STs 106, as described below, to isolate the problem down to an ST and/or a timeslot.

Specifically, the satellite 102 payload transmits the configurable gain controller (CGC) attenuator state values telemetry directly to the NOCC 104 every superframe. The CGC attenuator state value telemetry is sent from the payload to the NOCC, and the following pieces of information are used to interference detection: uplink frame counter time stamp (TOD), CGC Attenuator State Record for each CGC unit, CGC ID which is the identifier for the CGC unit, and state ID which is the latest state identifier value for the CGC set by the PCC. This state ID is used to determine when the PCC has adjusted the CGC gain value to compensate for high signal loss such as due to noise interference. The state ID can be converted into the actual dB value of the CGC unit.

If the CGC is set to excessively high values for extended periods of time, then there may be possible interference. The CGC adjustments need to be correlated with the uplink noise measurements sent by the payload of the satellite 102 since the CGC adjustments compensate and mask for uplink noise. The BC transmits the bandwidth assignments to the STs 106 in an uplink cell for each frame. The BC assigns contiguous timeslots to individual STs 106. This message is not sent to the NOCC 104 by the BC. Rather, the NOCC 104 has to sample this information from random STs 106 within the uplink cell. The BC bandwidth assignment messages each contain the following pieces of information that are used for interference detection: ST source ID address, uplink frame number (TOD), carrier rate, subband ID, uplink channel number, number of frames, starting timeslot, and number of contiguous timeslots.

This information is used to determine the assigned state of timeslots for each frame and to determine which ST 106 received the assignment by the BC. The NOCC 104 requests the ST 106 to buffer a number of snapshots of the following bandwidth assignment messages sent by the payload to be forwarded to the NOCC 104. This message is sent upon request by the NOCC 104 from NOCC operators as a tool to assist the NOCC operators when interference is suspected. The message is also sent automatically by the NOCC 104 on a configurable long, slow poll to selected random STs 106 in each uplink cell to collect interference information and to determine if interference is widespread across the network. The NOCC operators have the ability to send a message from the NOCC 104 to a given downlink microcell asking all STs 106 using a particular uplink allocation to respond to the NOCC 104. The NOCC operator can request for all STs 106 using a particular channel or a particular timeslot within a given channel. This command assists in determining which STs 106 are using a questionable channel or timeslot. The request from the NOCC 104 specifies an uplink frame counter duration over which the STs 106 check to see which ones acquire the particular uplink allocation.

The BC transmits its aggregated channel assignments for contention channels directly to the NOCC 104 at a configurable rate (i.e. about once an hour). When the telemetry is sent from the payload to the NOCC, the following pieces of information are used to interference detection: uplink frame counter time stamp (TOD), BC Statistics Record for each uplink cell for each of the 4 data rates, counter of uplink configured contention channels, and average count of uplink temporary contention channel. This information is used to determine how many channels to expect contention channel collisions. A collision detected on a non-contention channel may indicate the presence of interference as requested by the NOCC 104. If more granularity is needed then the next message sampled from STs 106 is used.

The BC transmits its dynamic temporary channel assignments for contention channels to the STs 106 in an uplink cell for each frame. This message is not sent to the NOCC 104 by the BC. The NOCC 104 has to sample this information from random STs 106 within the uplink cell. The BC contention channel assignment messages each contains the following pieces of information that are used for interference detection: uplink frame counter time stamp (TOD), and the uplink rate, control and/or data contention channel usage type, subband ID and uplink channel number for each uplink contention channel. This information is used to determine which channels to expect contention channel collisions. A collision detected on a non-contention channel may indicate the presence of interference as requested by the NOCC 104. The ST 106 buffers a number of snapshots of the following temporary contention channel assignment messages, sent by the payload, to be forwarded to the NOCC 104.

In addition, all assigned payload demodulators transmit their traffic monitoring telemetry directly to the NOCC 104 every superframe. The traffic telemetry sent is from the payload to the NOCC 104, and the following pieces of information are used for interference detection: uplink frame number time stamp (TOD), demodulator traffic statistics record for each demodulator, demodulator ID, and a Reed-Solomon uplink code block failure counter, which indicates the number of uplink code blocks that failed the Reed-Solomon decode and Reed-Solomon error correction. An uplink code block may fail due to several reasons such as a corrupted code block, collision of code blocks transmitted by different STs on a contention channel, or no ST transmitted code blocks into the timeslot.

As can be appreciated by one skilled in the art, normal contention channel collisions can be confused with or mask interference. Both collisions on contention channel timeslots, allocated timeslots without transmissions, and unallocated unused timeslots will be reflected in the Reed-Solomon uplink code block failure counter. Since they are reflected in this counter, using just this counter will allow undetected interference on non-contention timeslots for up to the number of contention channel timeslots. Interference detected through this means is likely to be external entities transmitting across more timeslots than there are contention timeslots. Since code failures are valid for contention timeslots, if timeslots allocations are unknown, then the code block failure counter can be used only to detect interference that produces magnitudes with more code block failures than contention timeslots would have. If the Reed-Solomon uplink code block failure counter is excessive above expected traffic utilization for the given time of day for the uplink, then there may be possible interference. The NOCC 104 would then need to collect samples of the uplink power control message from random STs in the suspect uplink cell.

All assigned payload demodulators transmit their uplink power control messages to the STs 106 in an uplink cell for each frame. This message is not sent to the NOCC 104 by the demodulators. The NOCC 104 has to sample this information from random STs 106 within the uplink cell. The uplink power control messages each contains the following pieces of information used for interference detection: a terminal address field which indicates which demodulator on the payload sent the message, and is used to determine which channels may have interference, a subband number, an uplink TDMA frame number, an uplink noise sample list for each carrier, a timeslot number for each carrier, an uplink block decode status list for each timeslot for each carrier, a received power for each timeslot for each carrier, and an early/late indicator for each timeslot for each carrier.

A command message requesting samples of the uplink power control message from STs 106 is sent by the NOCC 104, upon request from NOCC operators as a tool to assist the NOCC 104 operators when interference is suspected. The command message also is sent automatically by the NOCC 104 on a configurable long, slow poll to selected random STs 106 in each uplink cell to collect interference information and to determine if interference is widespread across the network. As requested by the NOCC 104, the ST 106 buffers a number of snapshots of the following uplink power control messages, sent by the payload, to be forwarded to the NOCC 104. If the received power is peaked at its maximum value for many samples of the uplink power control message for the same channel, then there may be possible interference.

An ST 106 transmitting too hot trying to overcome rain fade can cause side lobe interference with other STs 106. If the ST 106 is not able to reach the satellite, it may continue to increase power causing interference with other STs 106. If the uplink block decode status has unexpectedly failed for an unexpected large number of timeslots for many samples of the uplink power control messages for the same channel, then there may be possible interference. Also, if the early/late flag is unexpectedly set as either always early or always late for many samples of the uplink power control messages for the same timeslot, then there may be possible interference. Furthermore, if the noise measurement shows spikes or trends of unexpected values for the same carrier, or if the block decode value shows excessive coding failures over a period of time for allocated timeslots beyond normal under-utilization of those timeslots, then there may be possible interference. In addition, if the block decode value shows excessive coding failures over a period of time for contention channel timeslots beyond normal under-utilization of those timeslots and compensating for expected contention channel collisions, then there may be possible interference.

BC allocations can be compared with the power control information for the same uplink frame to determine if power levels indicate transmissions in timeslots that were not allocated for that frame or if no transmissions in timeslots were indicated due to low power levels even though the timeslot was allocated. If the block decoding failures cover time-contiguous ranges of timeslots or frequency-contiguous ranges of channels, then it may be a sign of an external entity transmitting on frequencies of the network 100 or an ST 106 is using incorrect frequencies for all timeslots, and there may be possible interference.

Since STs 106 get dedicated rate channels assigned to them by the BC for connections, STs 106 should not be receiving any unexpected interference on those allocated channels. The uplink frame noise, received power, and block decoding are reported to the ST 106 by the payload. If the received signal/noise power level is above a configured threshold relative to the frame noise level, then this should be considered sufficient power to be successfully received by the satellite 102. If the block decode fails for the transmission, then this is a good indication of interference. Also, if the connection is cleared unexpectedly and the cause of the clearing is related to the radio link, then there may be possible interference. Clearing related to the radio link can be caused by such things as an ST 106 never being able to get a successful message through its allocated timeslots as indicated by the block decoding in the uplink power control message.

ST transmission detailed status can be sampled from STs 106 by the NOCC 104. The detailed status information contains the specific requested ST's subset of its relevant BC allocation, power, and transmission information. As requested by the NOCC 104, the ST 106 collects the detailed status information for the number of the following frames to be forwarded to the NOCC 104 as a response. The ST transmission detailed status messages each contain the following pieces of information used for interference detection: a terminal address field that indicates which ST 106 sent the message, start uplink frame number (TOD), and number of frames duration. Also, each ST transmission message contains the following for each uplink channel timeslot in the uplink cell transmitted into by the ST 106, for use in detecting interference: uplink channel ID, uplink timeslot ID, channel mode (contention, non-contention, both) when transmitted into during this duration, number of transmissions for this ST into this timeslot, number of failed block decodings reported by satellite for this ST for this timeslot for its transmissions, power level transmitted for this ST for this timeslot, signal/noise level reported received by the payload for this ST for this timeslot, frame noise level reported received by the payload for this ST for this timeslot, and the number of failed block decodings transmitted by the satellite on the downlink as detected by the ST.

Radio link statistics can be configured to be collected periodically from STs 106 by the NOCC 104. These uplink and downlink statistics contain the following pieces of information used for interference detection: terminal address field that indicates which ST sent the message, start uplink frame number (TOD), number of frames duration for each traffic type (i.e. rate, high priority volume, low priority volume, contention, dedicated end-user data contention, etc), failed block codes counter for each timeslot summed over all frames, valid received power but invalid block coding counter for each timeslot summed over all frames, the number of bandwidth requests, number of bandwidth requests not responded to, the number of times ST uplink transmitting at maximum power, and the number of frames beacon not detected.

Possible interference can be determined from the following: if the radio link shows unexplained temporary loss of the beacon signal, possibly due to excessive downlink noise, if the ST reports an excessive number of invalid block decodes on contention channels that are not congested, or if the transmitted power was unable to achieve received power levels on the satellite in order to allow a valid block decoding for many samples for the same channel. Also, the uplink frame noise, received power, and the block decoding are reported to the ST 106 by the payload of the satellite 102. If the received signal/noise power level is above a configured threshold relative to the frame-noise level, then this should be considered sufficient power to be successfully received by the satellite and the “valid received power” counter is incremented. This assumes that rainy weather information at the NOCC 104 is correlated with the noise and power levels to account for rain fade being the cause of the interference symptoms.

Select STs 106 can also be configured by the NOCC 104 to attempt to send alarms to the NOCC 104 when the ST 106 detects interference such as with uplink transmission problems. Typically, only a small subset of all STs 106 are able to subscribe to this service because of the high overhead of alarms at the NOCC 104. Generally, premium high-end STs and critical STs such as SSTs and NSP/ISP STs are included in the subset. These alarms are generated by the STs 106 based upon thresholds that are configured by the NOCC 104.

Additional functions and operations of the NOCC 104 and the STs 106 will now be discussed.

The NOCC 104 is responsible for coordinating power control based upon detection of rain. This detection of rain events needs to be provided to NOCC operators who can correlate it with symptoms of interference to eliminate times when rain is the cause. The NOCC 104 is also responsible for predicting sun outages. This sun outage detection for microcells needs to be collected and provided to NOCC operators who can correlate it with symptoms of interference to eliminate times when sun outage is the cause. The NOCC 104 collects and stores telemetry from the satellite payload to assist in interference management.

Furthermore, the NOCC 104 analyzes transmission and reception errors and statistics for detecting ST misaligned antennas, updates capacity plans to disallow particular subbands from being used in particular uplink cells due to external interference with those subbands, and trends uplink frame noise telemetry from the payload to detect external interference. The NOCC 104 geographically correlates variations in uplink frame noise telemetry from the Payload to detect external interference, and correlates statistics collected from the payload and STs 106 by time of day for detecting interference.

The NOCC 104 further provides a reporting tool which can be used for reviewing statistics and for interference analysis, as well as the capability to collect interference data from PL telemetry and ST statistics, and the capability to store and report on PL telemetry and ST statistics. The NOCC 104 provides the capability to compare, different data streams at a minimum, as a function of time, by providing tools to assist in the analyzing of raw collected interference data for detecting interference as well as basic reports for displaying the raw collected interference data for detecting interference.

In addition, the NOCC 104 provides information on the payload configuration, demodulator assignments, and end-user contention channel allocations for interpreting interference data., and should be able to setup an uplink engineering channel to have STs 106 send test messages through the uplink engineering channel for interference verification. The NOCC 104 shall provide the means to remotely shut off the RF transmission of improperly operating STs 106, and be able to request STs 106 to send ST interference test messages for specific uplink channels.

The NOCC 104 also provides NOCC Operators with rain events that can be used in comparison over time with interference data in support of interference analysis with interference detection information, and provides the capability to retrieve and display predicted sun outage events.

The NOCC 104 is further able to command STs 106 in a microcell to report its channel or timeslot usage, and has STs with minimum and maximum ODU sizes at the NOCC sites to support interference detection testing. The NOCC 104 does not allow an ST 106 to register if the STs downlink transmission detailed status values are outside of acceptable ranges of values as configured at the NOCC 104.

In addition, the NOCC 104 collects and stores telemetry from the satellite payload to assist in interference management, and selects random STs 106 in each uplink cell to send summary statistics and snapshots of payload messages periodically to the NOCC 104 to assist in interference management.

The NOCC 104 is also able to temporarily disable sets of ST transmitters based on an ST bitmask in an uplink cell to assist in interference isolation, and is further able to block out particular channels and subbands in a particular uplink to avoid detected interference. The NOCC 104 also collects and store uplink and downlink transmission statistics, for example, aggregated ST summary status information about excessive ST transmission and reception errors and statistics, and collects and stores transmission and reception errors and statistics to be used in detecting ST misaligned antennas. The NOCC 104 further provides the capability to configure threshold values for transmission and reception errors, as well as the capability to detect when transmission and reception error thresholds have been crossed.

The NOCC 104 also allows for capacity plans to be updated to disallow particular subbands from being used in particular uplink cells due to external interference with those subbands, provides tools which can be used to trend uplink frame noise telemetry from the payload to detect external interference, and establishes configuration thresholds for the rate of change in the UL frame noise values and is capable of detecting when UL frame noise thresholds have been exceeded. The NOCC 104 also provides tools which can assist in geographically correlating variations in uplink frame noise telemetry from the payload to detect external interference.

The NOCC 104 is also able to command an ST 106 to disable transmissions under software command., is able to command sets of STs 106 to disable transmissions beginning on a NOCC specified uplink frame number for a NOCC specified number of uplink frames, and is able to enable transmissions for STs 106 that have had their transmissions disabled by the disable command. The NOCC is further able to disable sets of ST transmissions if the ST management port subaddress is within a NOCC specified range, and is able to disable sets of ST transmissions if the ST's geographic position is inside or outside a NOCC specified geographic region.

The NOCC operator attempts to determine the scope of interference by attempting the following:

Uplink-based Interference Detection—The NOCC operator identifies a suspect uplink area for possible interference and is trying to further localize it to which timeslot within an uplink is being interfered with.

Satellite Terminal-based Interference Detection—The NOCC operator has identified a suspect timeslot for possible interference and is trying to identify any STs that might be causing internal interference or trying to rule out internal interference because external interference is suspected.

System-wide Interference Detection—The NOCC operator looks for interference across several uplinks within the entire system.

The NOCC 104 can exercise satellite components by way of NOCC commands sent to an ST 106 for transmissions that request the BoD to use a particular uplink channel/frequency. Statistics and telemetry collected from the payload and STs 106 during these transmissions can be analyzed for patterns of failures and interference. Satellite components are exercised periodically and on-demand by NOCC Operators in order to detect or attempt to confirm the detection of interference on the operational in-service components. The satellite components can also be set up as an engineering channels to aid in further confirmation and isolation.

Furthermore, end customers report the following to their NSP customer help desk that can potentially be escalated to the NOCC customer help desk: end-user network connections being unexpectedly cleared, large number of end-user application level retransmission, poor end-user quality of service and end-user packets not getting through. External systems and companies typically report certain information to the NOCC 104, including spectrum analysis reports showing that equipment in the network 100 is causing interference on external entities in external systems.

The NOCC 104 can locate interference sources, based in part upon the information provided by the network 100 as described above. The NOCC 104 can determine the uplinks and downlinks with interference, determine the geographic area covered by interference and center point covered by interference, determine if the interference is intermittent or continuous; determine if the times of experiencing the interference are periodic or random, and determine if the interference is deliberate. The NOCC 104 can further determine if only the network 100 is affected or if other Ka-band systems are being affected, determine the uplink timeslots with interference, determine the ST 106 allocated the uplink timeslots with interference and ascertain if the ST 106 is the source of the interference, and use a spectrum analyzer to detect a pattern of interference.

The NOCC 104 is further capable of isolating interference caused by STs 106 by systematically turning off STs 106 to determine if interference continues. The NOCC operator systematically disables ST transmitters for a set of STs 106 within the suspected interference region by groups or one at a time, and monitors to see if the interference diminishes or goes away. The NOCC 106 performs this function by sending a message to STs 106 to select the subset of STs 106 that deactivates their transmitters starting at a specific frame number for a requested number of frames. This disabling and checking is typically only performed for a short period (i.e. less than a few minutes) and during non-peak times, if possible, as determined by the NOCC operator for each ST 106 in order to minimize any ST availability outages.

There are several different mechanisms that the NOCC 104 can use to select the group of STs 106 and inform that group of the interference. For example, the NOCC 104 can select the STs 106 in any of the following ways, and provide the interference information to the STs 106 within that selected group: select all STs 106 within a specified geographic region; select all STs 106 in an uplink cell, select all STs 106 in a downlink microcell, select all STs 106 that match a range of ST IDs, select all STs 106 that match a range of ST serial numbers (includes unregistered STs), or geographic area specified by latitude and longitude. Also, the terminal does not need to be registered into the system, but rather, just has to be able to receive. The NOCC 104 can deploy portable interference monitoring devices with directional receivers to pinpoint the direction and location of the interference, and can determine candidate external satellite or terrestrial systems that may be interfering at specific frequencies based upon their FCC frequency spectrum allocations adjacent to the allocations of the network 100.

Interference can also be located in other ways. For example, a helicopter having detection equipment on board can fly over the uplink region and attempt to locate the interference source. By making the detection area smaller, then aircraft rental costs necessary to examine the area can be reduced. Multiple satellites 102 over the same region could be enlisted to assist in some gross-level triangulation of the interference location once more than satellite 102 becomes operational over a region in different orbital slots. Also, other Ka band satellites 102 in nearby orbital slots that are external to the network 100 could potentially be enlisted to assist in gross-level triangulation of the interference location.

Given all of the data collected to determine if interference is suspected, the NOCC operator may need to verify or double check that interference is in fact occurring. This interference verification can be addressed using several techniques as described below. For example, the engineering channel can be used for uplink interference verification and isolation. During non-peak traffic times, the NOCC operator assigns another demodulator with an unused subband to the suspect uplink. The BC then moves all traffic to that new demodulator. The NOCC operator takes the suspect subband's demodulator out of the pool of BC demods leaving the demodulator in-service but only used for management purposes by the NOCC 104. The NOCC operator sets the demodulator up for NOCC testing and has randomly selected STs 106 generate messages through that given demodulator's channels to validate that interference exists and is still continuing on that subband/frequency. This must work within the constraints of the agility of the randomly selected ST 106 so as not to be intrusive on the end-user traffic.

In order to avoid or turn off interference, the NOCC 104 can remotely disable the transmitter on an interfering ST 106 and have the ST 106 serviced by their NSP. The NOCC 104 can account for interference in the allocation of specific resources being interfered with by removing frequency subbands being interfered with from allocated frequencies for the problem uplink cell, and switching to a different downlink polarity for a given microcell to avoid interference. This is done only when absolutely necessary since it would potentially cause disruption in user traffic until all STs 106 are updated with the new polarity once it is changed. The NOCC 104 can also avoid interference by providing greater frequency reuse separation due to sidelobe interference between STs 106 beyond the designed and expected levels.

The NOCC 104 also collects information from the satellite 102 to assist system operators in detecting the presence of interference. The management layer protocol shall enables an ST 106 to report on suspected interference to the NOCC 104. The network 100 provides associated information storage, filtering and reporting to assist system operators in detecting the presence of interference and in identifying the type and source of the interference. The network 100 provides the means to remotely shut off the RF transmission of improperly operating STs 106, and provides the means to reconfigure satellite resources to assist in mitigating the effects of interference, under the control of the NOCC 104 as described above.

Further operations of the STs 106 will now be described. It is noted that selected STs 106 send summary statistics and snapshots of payload messages periodically to the NOCC 104 to assist in interference management. STs 106 send to the NOCC 104 a set of satellite payload generated messages sent to STs 106 including the system information and uplink power control messages to assist in interference management when requested by the NOCC 104. The NOCC 104 collects the satellite payload generated messages from STs 106 in each uplink cell including the system information and uplink power control messages.

Each ST 106 provides the frame number in its statistics for detecting interference within a frame accuracy, and upon request or as periodically configured, provides the minimum, maximum and aggregate values for the statistics sent to the NOCC 104 on the ST's transmitted power levels, payload reported power levels, and payload reported block decodes for its own transmissions.

STs 106 also provide samples to the NOCC 104 on request by the NOCC 104 of the requested number of following snapshots of uplink power control messages, bandwidth allocation messages, and contention channel assignments sent by the payload to the ST 106. STs 106 also report clear codes as part of connection clearing messages. Furthermore, STs 106 are able to temporarily disable their transmitter for a specified amount of time as requested by the NOCC 104, are able to sent test messages through a specified uplink engineering channel as requested by the NOCC 104, and provide the means for the NOCC 104 to remotely disable its RF transmission.

In addition, STs shall be able to request the payload for specific uplink channels as directed by the NOCC 104 to send ST interference test messages. The ST 106 reports to the NOCC 104, when requested, the ST's usage of a specified channel and timeslot for a configurable number of frames in the future, and reports its downlink transmission detailed status values during ST registration. The ST 106 is capable of detecting and shutting off spurious transmissions, droping its carrier if the ST software fails, and providing the ability to disable transmissions under software command. The ST 106 also disables transmissions beginning on a NOCC specified uplink frame number for a NOCC specified number of uplink frames when the NOCC 104 issues a disable command, and the STs 106 enable transmissions as commanded by the NOCC 104 that have had their transmissions disabled by the disable command. STs 106 that are disabled because of barring or other individual reasons generally are not reenabled until such reasons are resolved.

Selected STs 106 shall send summary statistics and snapshots of payload messages periodically to the NOCC 104. STs 106 also send to the NOCC 104 a set of satellite payload generated messages sent to STs 106 including the system information and uplink power control messages when requested by the NOCC 104. STs 106 are further able to be commanded by the NOCC 104 to use an engineering channel, record uplink and downlink transmission statistics, report aggregated summary status information about excessive transmission and reception errors and statistics.

In summary, the system and method according to the embodiments of the present invention described above is capable of controlling the NOCC 104 and payload of the satellite 102 to identify and isolate STs 106 the are producing interference in communication in the network 100. The system and method are further capable of controlling the NOCC 104 and payload of the satellite 102 to deactivate such interfering STs 106 based on any of the following: uplink cell by uplink cell, one uplink cell at a time; downlink microcell by downlink microcell, one microcell at a time; all STs 106 receiving a CONUS beam; by satellite region in a network having multiple satellites; by geographic area; all STs within a range of ST management destination subaddresses within a cell microcell; all STs within a range of ST's electronic serial numbers; and all STs having a particular supplier serial number, to name a few. However, the system and method can control the NOCC 104 and satellite 102 to identify and deactivate STs 106 based on any desirable criteria independent or dependent on the uplink and downlink cells in which the STs 106 reside. Furthermore, the system and method need not be limited to a satellite communications network, but rather, can be employed in any other suitable network, such as a terrestrial-based network, and so on, having user terminals.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined the following claims.

What is claimed is:

1. A system for managing interference in a communications network which establishes communication cells at respective locations on the surface of the earth to enable communication between a plurality of user terminals, comprising:
an interference detector, adapted to detect interference in said network which interferes with an ability of at least one user terminal to communicate in said network; and
an interference source identifier, adapted to identify a source of said interference by deactivating at least one select group of said user terminals based on criteria independent of the respective cell or cells in which said user terminals reside, to locate those of said terminals whose ability to communicate in said network is being interfered with by said detected interference.

2. A system as claimed in claim 1, wherein:
said communications network includes a satellite communications network and said user terminals include satellite terminals; and
said interference source identifier deactivates said at least one select group of said satellite terminals.

3. A system as claimed in claim 1, wherein:
said interference source identifier deactivates said at least one select group of user terminals which are all located within a portion of a single cell.

4. A system as claimed in claim 1, wherein:
said interference source identifier deactivates said at least one select group of user terminals which are located within multiple cells.

5. A system as claimed in claim 1, wherein:
said interference source identifier deactivates said at least one select group of user terminals which are all located in a respective geographic region having a size independent of a size of any of said cells.

6. A system as claimed in claim 1, wherein:
said interference source identifier deactivates said at least one select group of user terminals having data receiving addresses within a particular range of addresses.

7. A system as claimed in claim 1, wherein:
said interference source identifier deactivates said at least one select group of user terminals having user terminal identifiers within a particular range of user terminal identifiers.

8. A system as claimed in claim 1, wherein:
said interference source identifier deactivates said at least one select group of user terminals having a particular supplier identifier which identifies a supplier of said user terminals.

9. A method for managing interference in a communications network which establishes communication cells at respective locations on the surface of the earth to enable communication between a plurality of user terminals, comprising:
detecting interference in said network which interferes with an ability of at least one user terminal to communicate in said network; and
identifying a source of said interference by deactivating at least one select group of said user terminals based on criteria independent of the respective cell or cells in which said user terminals reside, to locate those of said terminals whose ability to communicate in said network is being interfered with by said detected interference.

10. A method as claimed in claim 9, wherein:
said communications network includes a satellite communications network and said user terminals include satellite terminals; and
said interference source identifier deactivates said at least one select group of said satellite terminals.

11. A method as claimed in claim 9, wherein:
said interference source identifying step deactivates said at least one select group of user terminals which are all located within a portion of a single cell.

12. A method as claimed in claim 9, wherein:
said interference source identifying step deactivates said at least one select group of user terminals which are located within multiple cells.

13. A method as claimed in claim 9, wherein:
said interference source identifying step deactivates said at least one select group of user terminals which are all located in a respective geographic region having a size independent of a size of any of said cells.

14. A method as claimed in claim 9, wherein:
said interference source identifying step deactivates said at least one select group of user terminals having data receiving addresses within a particular range of addresses.

15. A method as claimed in claim 9, wherein:
said interference source identifying step deactivates said at least one select group of user terminals having user terminal identifiers within a particular range of user terminal identifiers.

16. A method as claimed in claim 9, wherein:
said interference source identifying step deactivates said at least one select group of user terminals having a particular supplier identifier which identifies a supplier of said user terminals.

17. A computer-readable medium of instructions, adapted to control a communications network to manage interference in said communications network which establishes communication cells at respective locations on the surface of the earth to enable communication between a plurality of user terminals, said computer-readable medium of instructions comprising:
a first set of instructions, adapted to control said communications network to detect interference in said network which interferes with an ability of at least one user terminal to communicate in said network; and
a second set of instructions, adapted to control said communications network to identify a source of said interference by deactivating at least one select group of said user terminals based on criteria independent of the respective cell or cells in which said user terminals reside, to locate those of said terminals whose ability to communicate in said network is being interfered with by said detected interference.

18. A computer-readable medium of instructions as claimed in claim 17, wherein:
said communications network includes a satellite communications network and said user terminals include satellite terminals; and
said second set of instructions controls said communications network to deactivate said at least one select group of said satellite terminals.

19. A computer-readable medium of instructions as claimed in claim 17, wherein:
said second set of instructions controls said communications network to deactivate said at least one select group of user terminals which are all located within a portion of a single cell.

20. A computer-readable medium of instructions as claimed in claim 17, wherein:
said second set of instructions controls said communications network to deactivate said at least one select group of user terminals which are located within multiple cells.

21. A computer-readable medium of instructions as claimed in claim 17, wherein:
said second set of instructions controls said communications network to deactivate said at least one select group of user terminals which are all located in a respective geographic region having a size independent of a size of any of said cells.

22. A computer-readable medium of instructions as claimed in claim 17, wherein:
said second set of instructions controls said communications network to deactivate said at least one select group of user terminals having data receiving addresses within a particular range of addresses.

23. A computer-readable medium of instructions as claimed in claim 17, wherein:
said second set of instructions controls said communications network to deactivate said at least one select group of user terminals having user terminal identifiers within a particular range of user terminal identifiers.

24. A computer-readable medium of instructions as claimed in claim 17, wherein:
said second set of instructions controls said communications network to deactivate said at least one select group of user terminals having a particular supplier identifier which identifies a supplier of said user terminals.
